(19) United States
(12) Patent Application Publication
(10) Pub. No.: US 2018/0176654 A1
(43) Pub. Date: Jun. 21, 2018

(54) ELECTRONIC APPARATUS AND CONTROL METHOD THEREOF

(71) Applicant: SAMSUNG ELECTRONICS CO., LTD., Suwon-si (KR)

(72) Inventors: Yea-seul SONG, Seoul (KR); Yeon-woo KIM, Seongnam-si (KR); Tae-hun KIM, Seoul (KR); Young-jin LEE, Suwon-si (KR)

(21) Appl. No.: 15/813,532

(22) Filed: Nov. 15, 2017

(30) Foreign Application Priority Data
Dec. 20, 2016 (KR) 10-2016-0174329

(51) Int. Cl. H04N 21/482; H04N 21/431; H04N 5/445; H04N 21/488; H04N 21/462

(52) U.S. Cl. CPC H04N 21/4821; H04N 21/4316; H04N 2005/44556; H04N 21/488; H04N 21/4622; H04N 5/44582

(57) ABSTRACT

Disclosed is an electronic apparatus. The electronic apparatus includes: a first receiver, a second receiver and a controller. The first receiver includes circuitry that receives a first broadcast signal transmitted in a first data transmission mode. The second receiver includes circuitry that receives a second broadcast signal transmitted in a second data transmission mode different from the first data transmission mode. The controller is configured to extract first guide information about a first broadcast program from the first broadcast signal, to extract second guide information about a second broadcast program from the second broadcast signal, and to generate and provide integrated guide information about the first and second broadcast programs. Thus, accurate guide information about content may be provided to a user.

### CROSS-REFERENCE TO RELATED APPLICATION

The application is based on and claims priority under 35 U.S.C. § 119 to Korean Patent Application No. 10-2016-0174329 filed on Dec. 20, 2016 in the Korean Intellectual Property Office, the disclosure of which is incorporated by reference herein in its entirety.

### BACKGROUND

### Field

The present disclosure relates generally to an electronic apparatus and a control method thereof, and for example, to an electronic apparatus which receives a broadcast signal and provides guide information about use of content embedded in the broadcast signal, and a control method thereof.

### Description of Related Art

Recently, a television (TV), a set-top box and the like electronic apparatus capable of receiving a broadcast signal supports a hybrid function of receiving a broadcasting signal through a terrestrial channel or a broadcasting signal through a broadband channel of Internet or the like network. As the kind and amount of content provided through various paths are gradually increased, it is more inconvenient for a user to find desired content.

To address such inconvenience, a conventional electronic apparatus provides guide information about use of content based on program information received with a radio frequency (RF) signal or metadata provided from a server.

However, the conventional program information is received separately from the content and does not match with the actually provided content. Further, if only the metadata having a long update frequency is used, there is a problem of decreasing accuracy since a sudden change in a program is not reflected.

### SUMMARY

An aspect of one or more example embodiments provides an electronic apparatus, which provides guide information of high accuracy to a user among pieces of guide information received through different data transmission modes to thereby improve convenience of using content, and a control method thereof.

In accordance with an example embodiment, the electronic apparatus includes: a first receiver comprising circuitry configured to receive a first broadcast signal transmitted in a first data transmission mode; a second receiver comprising circuitry configured to receive a second broadcast signal transmitted in a second data transmission mode different from the first data transmission mode; and a controller configured to extract first guide information about a first broadcast program from the first broadcast signal, to extract second guide information about a second broadcast program from the second broadcast signal, and to generate and provide integrated guide information about the first and second broadcast programs. Thus, a wealth of accurate information is provided to a user and it is thus convenient for the user to use the broadcast program.

The controller may replace, upgrade or update a part of the integrated guide information corresponding to the second guide information within the integrated guide information with third guide information based on attributes of the third guide information if the third guide information about the second broadcast program is received through the first broadcast signal after generating the integrated guide information.

The controller may replace, upgrade or update a part of the integrated guide information corresponding to the second guide information within the integrated guide information with third guide information if the third guide information is more recently generated than the second guide information.

The controller may replace, upgrade or update a schedule of the second broadcast program within the integrated guide information with the third guide information if the third guide information is related to the schedule including a start time and an end time of the second broadcast program.

The controller may replace, upgrade or update at least one of a genre, a description, a rating and a preview of the second broadcast program within the integrated guide information with the third guide information if the third guide information includes at least one of the genre, the description, the rating and the preview of the second broadcast program.

The controller may compare the third guide information and the second guide information with respect to a data size, and may replace, upgrade or update a part of the integrated guide information corresponding to the second guide information within the integrated guide information with the third guide information if the third guide information has a larger data size than the second guide information.

The controller may replace, upgrade or update a part of the integrated guide information corresponding to the second guide information within the integrated guide information with the third guide information based on at least one of a provider of the third guide information and reliability of the third guide information.

If fourth guide information about the first broadcast program is received through the second broadcast signal, the controller may replace, upgrade or update a part of the integrated guide information corresponding to the first guide information within the integrated guide information with the fourth guide information based on attributes of the fourth guide information.

The third guide information may be more frequently updated than the fourth guide information.

The fourth guide information may have a larger data size than the third guide information.

The controller may provide a UI for allowing a user to edit the integrated guide information.

In accordance with an example embodiment, a method of controlling an electronic apparatus includes: receiving a first broadcast signal transmitted in a first data transmission mode; receiving a second broadcast signal transmitted in a second data transmission mode different from the first data transmission mode; and extracting first guide information about a first broadcast program from the first broadcast signal, and second guide information about a second broadcast program from the second broadcast signal, and generating and providing integrated guide information about the first and second broadcast programs. Thus, more accurate information is provided to a user and it is thus convenient for the user to use the content.

The method may further include: replacing a part of the guide information corresponding to the second guide information within the integrated guide information with third guide information according to attributes of the third guide information if the third guide information about the second broadcast program is received through the first broadcast signal.

The replacing a part of the guide information corresponding to the second guide information within the integrated guide information with third guide information may include: replacing a part corresponding to the second guide information within the integrated guide information with third guide information if the third guide information is more recently generated than the second guide information.

The replacing a part of the guide information corresponding to the second guide information within the integrated guide information with third guide information may include: replacing a schedule of the second broadcast program within the integrated guide information with the third guide information if the third guide information is related to the schedule including a start time and an end time of the second broadcast program.

The replacing a part of the guide information corresponding to the second guide information within the integrated guide information with third guide information may include: replacing at least one of a genre, a description, a rating and a preview of the second broadcast program within the integrated guide information with the third guide information if the third guide information includes at least one of the genre, the description, the rating and the preview of the second broadcast program.

The replacing a part of the guide information corresponding to the second guide information within the integrated guide information with third guide information may include: comparing the third guide information and the second guide information with respect to a data size; and replacing a part of the guide information corresponding to the second guide information within the integrated guide information with the third guide information if the third guide information has a larger data size than the second guide information.

The replacing a part of the guide information corresponding to the second guide information within the integrated guide information with third guide information may include: replacing a part corresponding to the second guide information within the integrated guide information with the third guide information based on at least one of a provider of the third guide information and reliability of the third guide information.

The method may further include: replacing a part of the guide information corresponding to the first guide information within the integrated guide information with fourth guide information based on attributes of the fourth guide information, if the fourth guide information about the first broadcast program is received through the second broadcast signal.

The third guide information may be more frequently updated than the fourth guide information.

The fourth guide information may have a larger data size than the third guide information.

The method may further include: providing a UI for allowing a user to edit the integrated guide information.

### BRIEF DESCRIPTION OF THE DRAWINGS

The above and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example electronic apparatus according to an example embodiment;

FIG. 2 is a block diagram illustrating an example configuration of an example electronic apparatus according to an example embodiment;

FIG. 3 is a diagram illustrating an example of guide information according to an example embodiment;

FIG. 4 is a diagram illustrating an example of guide information according to an example embodiment;

FIG. 5 is a diagram illustrating an example of receiving the guide information through each broadcast signal according to an example embodiment;

FIG. 6 is a diagram illustrating an example of providing the guide information embedded in each broadcast signal according to an example embodiment;

FIG. 7 is a diagram illustrating an example of replacing a schedule fragment of the existing guide information with additional guide information embedded in the broadcast signal according to an example embodiment;

FIG. 8 is a diagram illustrating an example of replacing a content fragment of the existing guide information with additional guide information embedded in the broadcast signal according to an example embodiment;

FIG. 9 is a diagram illustrating example details of fragments of the guide information according to an example embodiment;

FIG. 10 is a diagram illustrating an example of a user interface (UI) provided for allowing a user to edit the guide information according to an example embodiment;

FIG. 11 is a block diagram illustrating example ATSC 3.0 standards according to an example embodiment;

FIG. 12 is a diagram illustrating an example of obtaining guide information of a first broadcast signal in the ATSC 3.0 standards according to an example embodiment;

FIG. 13 is a diagram illustrating an example of obtaining guide information of a second broadcast signal in the ATSC 3.0 standards according to an example embodiment; and

FIG. 14 is a flowchart illustrating an example method of operating an electronic apparatus according to an example embodiment.

### DETAILED DESCRIPTION

Below, various example embodiments will be described in greater detail with reference to accompanying drawings. The following descriptions of the example embodiments are made by referring to elements illustrated in the accompanying drawings, in which like numerals refer to like elements having substantively the same functions.

In the description of the example embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the scope of the disclosure.

The present disclosure may be applied to an electronic apparatus that receives a network signal of a selected channel and provides content to a user.

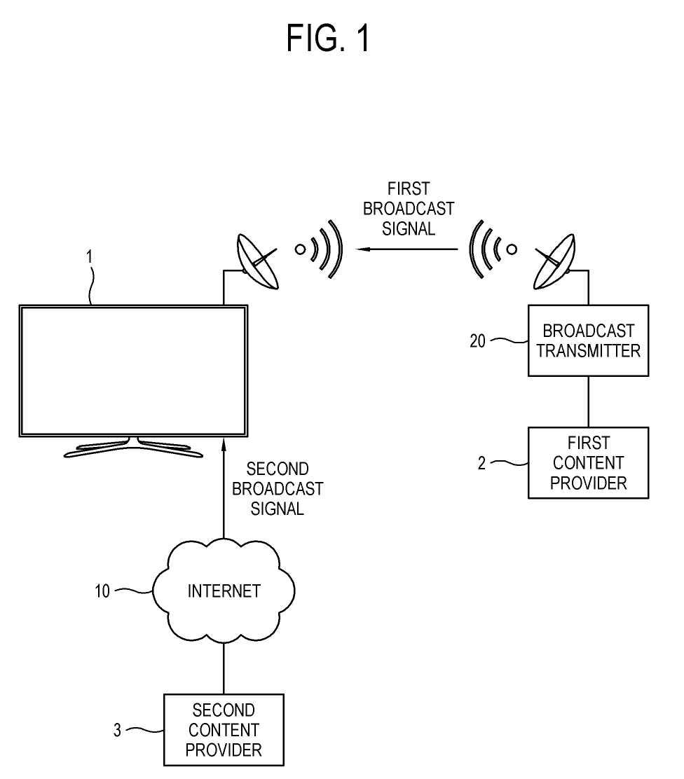

FIG. 1 is a diagram illustrating an example electronic apparatus according to an example embodiment. The electronic apparatus 1 according to an example embodiment may be materialized, for example, and without limitation, by a TV. The electronic apparatus 1 may be materialized, for example, and without limitation, by a smart phone, a tablet computer, a mobile phone, a personal computer, a multimedia player, an electronic frame, a digital signboard, a large format display (LFD), a digital signage, a set-top box, a smart watch, a head-mount display or the like wearable device, a refrigerator, or the like apparatus capable of receiving a network signal and providing content, or the like, but is not limited thereto.

In this example embodiment, the electronic apparatus 1 uses a first data transmission mode to receive a first broadcast signal, and uses a second data transmission mode different from the first data transmission mode to receive a second broadcast signal. For example, the data transmission mode includes a terrestrial transmission mode and a network transmission mode. The broadcast signal includes a signal broadcast by a content provider 2 or 3 through each transmission mode. For example, the electronic apparatus 1 receives a first broadcast signal from a broadcast signal transmitter 20 of a first content provider 2 in the first data transmission mode through a terrestrial path. Further, the electronic apparatus 1 is connected to a network 10 and receives a second broadcast signal from a second content provider 3 in the second data transmission mode. For example, the network may include the Internet 10, but is not limited thereto. Each broadcast signal includes a plurality of channels, and each channel includes content, a broadcast program, and guide information about the content and the broadcast program provided by the content providers 2 and 3. For example, the first broadcast signal may include first guide information about a first broadcast program, and the second broadcast signal may include second guide information about a second broadcast program. The content or the broadcast program may include a TV program provided in real time or video on demand (VOD) provided in response to a user's request. The guide information embedded in the broadcast signal may include an electronic service guide or electronic program guide for guiding use of content, or channel information for allowing the electronic apparatus 1 to receive a channel of each broadcast signal. In the foregoing description, ‘first’ and ‘second’ are used just for distinguishing between different data transmission modes and between different broadcasting signals. The ordinal numbers used herein are not to be construed as limiting the present disclosure.

According to an example embodiment, if a condition for providing the guide information is satisfied, for example, if a user's input is received or a specific channel is selected, the electronic apparatus 1 provides a user with the guide information for guiding use of content based on the guide information embedded in each broadcast signal. The guide information may for example include information about content such as a schedule of content, a description of content, a genre, a rating, a preview, or the like, but is not limited thereto. The electronic apparatus 1 extracts the first guide information about the first broadcast program from the first broadcast signal, extracts the second guide information about the second broadcast program from the second broadcast signal, and provides the integrated guide information. The integrated guide information may be generated by providing both pieces of guide information, may be generated from a more accurate one selected based on attributes between the two pieces of guide information, or may be generated by combining parts of the respective pieces of guide information. The electronic apparatus 1 may use one piece of the received guide information to replace, upgrade or update a corresponding part of the other guide information of the integrated guide information.

In this example embodiment, the pieces of guide information embedded in the different broadcast signals are combined and provided based on the attributes of the guide information, so that a sudden change in a program can be reflected, a lot of information can be provided, and so forth, thereby providing more accurate and detailed information to a user.

According to another example embodiment, the electronic apparatus 1 may extract the first guide information about the first broadcast program from the first broadcast signal and the second guide information about the first broadcast program from the second broadcast signal, and generate and provide the integrated guide information about the first broadcast program based on information having a first attribute in the first guide information and information having a second attribute in the second guide information.

For example, guide information about one broadcast program is received through the first broadcast signal and the second broadcast signal. The electronic apparatus 1 generates and provides the integrated guide information by referring to information about a schedule of a broadcast program, in which accuracy is important, from the first guide information that is frequently updated and quickly reflects a change, and referring to information about content of the broadcast program, in which content and quantity are important, from the second guide information that is infrequently updated and can include much information. However, there are no limits to the generation and provision of the integrated guide information.

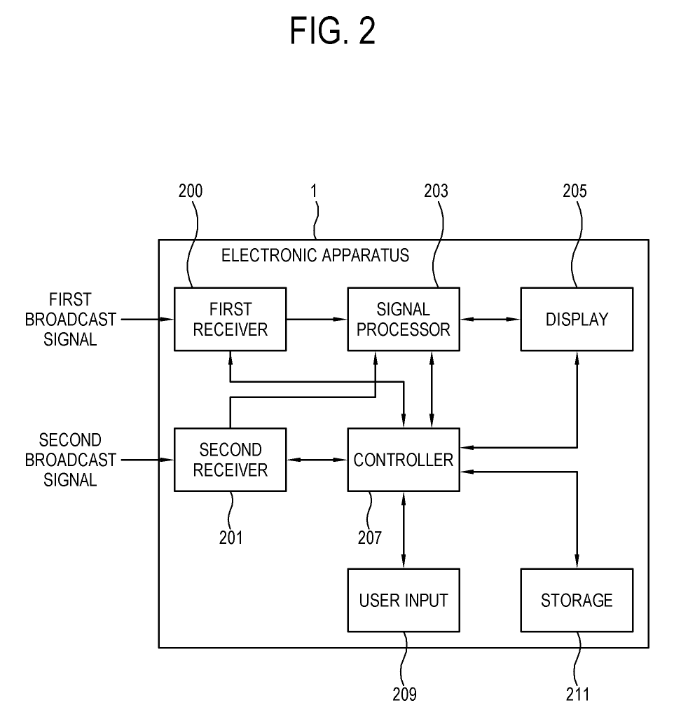

FIG. 2 is a block diagram illustrating an example configuration of an example electronic apparatus according to an example embodiment. The electronic apparatus 1 includes a first receiver (e.g., including receiver circuitry) 200, a second receiver (e.g., including receiver circuitry) 201 and a controller (e.g., including processing circuitry) 207. The electronic apparatus 1 according to an example embodiment may further include at least one of a signal processor (e.g., including signal processing circuitry) 203, a display 205, a user input (e.g., including input circuitry) 209 and a storage 211. The structure of the electronic apparatus 1 illustrated in FIG. 2 is merely given by way of example, and the electronic apparatus 1 according to an example embodiment may include another element in addition to the elements of FIG. 2. or exclude a certain element(s) from the elements shown in FIG. 2.

The first receiver 200 may include various circuitry and receives the first broadcast signal. The first receiver 200 may receive the first broadcast signal from the broadcast signal transmitter 20, or may receive the first broadcast signal from a repeater for repeating the first broadcast signal from the broadcast signal transmitter 20. The first receiver 200 may include various receiver circuitry, such as, for example, and without limitation, a tuner for receiving the first broadcast signal transmitted in the first data transmission mode. The tuner may be tuned to a channel selected by a user among channels corresponding to a plurality of first broadcast signals. In this example embodiment, the first broadcast signal may, for example, and without limitation, be a digital TV signal that complies with ATSC 3.0 standards. However, there are no limits to the standards of the first broadcast signal according to an example embodiment. As described above, the first broadcast signal received through the first receiver 200 includes the first broadcast program, and the first guide information about the first broadcast program.

The electronic apparatus 1 may receive the first broadcast signal from a broadcast signal receiver including various circuitry for receiving the first broadcast signal. For example, the broadcast signal receiver is connected to the electronic apparatus 1, receives the first broadcast signal from the broadcast signal transmitter 20 of the first content provider 2, and transmits the received first broadcast signal to the first receiver 200. The broadcast signal receiver may include various circuitry, such as, for example, and without limitation, a universal serial bus (USB) dongle.

The electronic apparatus 1 may further include a communicator comprising communication circuitry capable of communicating with an external device. The communicator includes the second receiver 201. The second receiver 201 includes various receiver circuitry and is connectable with a network and receives the second broadcast signal from a network server in the second data transmission mode. The second receiver 201 may, for example, and without limitation, perform wired communication with a plurality of servers through a wired local area network (LAN). The second broadcast signal may, for example, and without limitation, be a broadband signal that complies with the ATSC 3.0 standards. The second receiver 201 may include various circuitry, such as, for example, and without limitation, an RF circuit for transmitting and receiving an RF signal to perform wireless communication with an external device, and perform, for example, and without limitation, at least one of, near field communication (NFC) and a wireless USB. The second broadcast signal includes the second broadcast program, and the second guide information about the second broadcast program.

The user input 209 may include various input circuitry and receives a user's input and transmits it to the controller 207. The user input 209 may be variously materialized according to user's inputs. For example, the user input 209 may include various input circuitry, such as, for example, and without limitation, a menu button provided on an outer side of the electronic apparatus 1, a remote control signal receiver for receiving a remote control signal corresponding to a user's input received from a remote controller, a touch screen provided on the display 205 and sensing a user's touch input, a camera for sensing a user's gesture input, a microphone for sensing a user's voice input, a sensor for sensing a user's motion or position, or the like. The user's input may include, for example, a channel selection command for selecting a certain channel based on the guide information. The electronic apparatus 1 receives a signal of a channel selected based on the channel selection command and provides content to a user.

The storage 211 is configured to store a variety of data in the electronic apparatus 1. The storage 211 may include, for example, a non-volatile memory such as a flash memory, an erasable programmable read-only memory (EPROM), an electrically erasable programmable read-only memory (EEPROM), etc. The storage 211 in the electronic apparatus 1 may further include a volatile memory such as a dynamic random access memory (DRAM) or a static random access memory (SRAM) having a reading or writing speed faster than that of the nonvolatile memory. For example, the storage 211 may store the guide information embedded in the first broadcast signal and the second broadcast signal.

The signal processor 207 may include various signal processing circuitry and applies a signal process to broadcast signals received in the first receiver 200 and the second receiver 201, and outputs the processed signal to the display 205 so that the display 205 can display an image of a broadcast program. The signal process performed by the signal processor 203 may include, for example, and without limitation, demultiplexing for dividing a content signal including an image and a sound into sub streams of a video signal, an audio signal and appendix data; de-interlacing for converting an interlaced-type video signal into a progressive-type video signal; scaling for adjusting a resolution of a video signal; noise reduction for improving quality of an image; detail enhancement; frame refresh rate conversion; or the like.

The electronic apparatus 1 may further include a display 205 for providing content according to an example embodiment. The display 205 displays an image of content based on the signal processed by the signal processor 203. There are no limits to the type of display 205, and the display 205 may be for example materialized by various display types such as liquid crystal, plasma, a light-emitting diode, an organic light-emitting diode, a surface-conduction electron-emitter, a carbon nano-tube), nano-crystal, or the like.

If the display 205 is the type of liquid crystal, it includes a liquid crystal display panel, a backlight unit for emitting light to the liquid crystal display panel, a panel driving substrate for driving the liquid crystal display panel, etc. The display 205 may be materialized by a self-emissive organic light emitting diode (OLED) panel without the backlight unit.

The controller 207 may include various processing circuitry and performs control for operating general elements of the electronic apparatus 1. The controller 207 may include a control program for implementing such control, a nonvolatile memory in which the control program is installed, a volatile memory to which the installed control program is at least partially loaded, and various processing circuitry, such as, for example, and without limitation, at least one microprocessor, dedicated processor or central processing unit (CPU) for executing the loaded control program. The control program may include program(s) in the form of at least one among a basic input/output system (BIOS), a device driver, an operating system (OS), a firmware, a platform, and an application program. According to an example embodiment, the application program may be previously installed or stored in the electronic apparatus 1 when the electronic apparatus 1 is manufactured, or installed later in the electronic apparatus 1 based on data of an application program received from the outside when it is needed. The data of the application program may be for example downloaded from an application market and the like external server to the electronic apparatus 1.

According to an example embodiment, the controller 207 generates the integrated guide information by extracting the first guide information about the first broadcast program from the first broadcast signal and the second guide information about the second broadcast program from the second broadcast signal. The controller 207 provides the generated integrated guide information to a user. If third guide information about the second broadcast program is received through the first broadcast signal, the controller 207 may replace, upgrade or update a part or the guide information corresponding to the second guide information in the integrated guide information with the third guide information based on attributes of the third guide information.

The attributes of the guide information are to set references such as a date of generation, a data size, a user's preference, or the like, for directly or indirectly determining accuracy of matching with actual content. For example, if accuracy is determined with respect to a schedule of a broadcast program, the controller 207 may determine that the accuracy becomes higher as the schedule more lately made based on the attributes of the schedule. Likewise, in determining the accuracy of a description, a preview, or the like, of the content, the controller may determine that the accuracy becomes higher as the data size of the guide information has more data size based on their attributes.

The guide information may include information about different items with regard to one broadcast program, information about different broadcast programs, or information about some different content of the same items with regard to one broadcast program. For example, the first guide information received through the first broadcast signal may include schedule information about AA content of a first channel, and the second guide information received through the second broadcast signal may include schedule information about BB channel of the first channel. The first guide information may include schedule information about the AA content, and the second guide information may include description information about the AA content. Further, the first guide information may include schedule information of providing the AA content from 16:00 to 18:00, and the second guide information may include schedule information of providing the AA content from 16:00 to 19:00. The controller 207 extracts information from the guide information, and generates the integrated guide information based on the information selected based on the attributes of each piece of the guide information.

If the broadcast signals include pieces of guide information about different broadcast programs, the controller 207 generates the integrated guide information to simultaneously provide consistent pieces of guide information. On the other hand, if the pieces of guide information are inconsistent with each other, for example, when the broadcast signals include the guide information about the same broadcast program or there is a conflict in guide information or schedule between different broadcast programs, the electronic apparatus 1 generates the integrated guide information to selectively provide one of the pieces of inconsistent guide information based on the attributes.

As an example of the inconsistent guide information, if the first guide information is more recently generated than the inconsistent second guide information, the schedule of the broadcast program included in the first guide information is preferentially provided. If the data size of the second guide information is greater than that of the first guide information, the description of the broadcast program included in the inconsistent second guide information may be preferentially provided.

The electronic apparatus 1 may compose the guide information in accordance with characteristics of the broadcast signal. For example, the first broadcast signal accurately reflects a change in a schedule of content since its guide information is frequently updated due to a terrestrial broadcasting characteristic. The second broadcast signal accurately reflects a description and a preview of the broadcast program since it can carry a larger amount of data than the first broadcast signal due to a broadband broadcasting characteristic and thus embed a massive amount of information therein. However, the second broadcast signal does not immediately reflect a change since it is infrequently updated. In this example embodiment, the electronic apparatus 1 generates the integrated guide information with the schedule of the broadcast program based on the first guide information and the description or the like of the broadcast program based on the second guide information, thereby providing the integrated guide information to a user.

According to an example embodiment, third guide information or fourth guide information may be additionally received through the first broadcast signal and/or the second broadcast signal. If the third guide information and the fourth guide information do not conflict with the already-generated and provided integrated guide information, they may be added to the integrated guide information. If there is a conflict between the integrated guide information and the third and fourth guide information, an inconsistent part of the integrated guide information is replaced, upgraded or updated. At this time, a corresponding part of the second guide information received through the second broadcast signal may be replaced in the integrated guide information by the third guide information received through the first broadcast signal, or a corresponding part of the first guide information received through the first broadcast signal may be replaced in the integrated guide information by the fourth guide information received through the second broadcast signal.

Below, composition of guide information and a method of providing the guide information according to an example embodiment will be described in greater detail with reference to accompanying drawings.

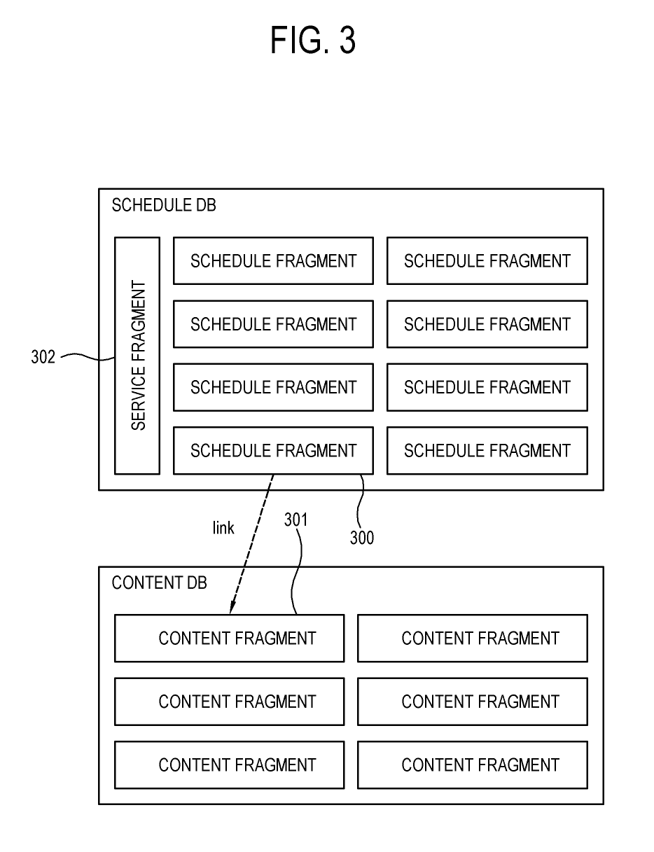

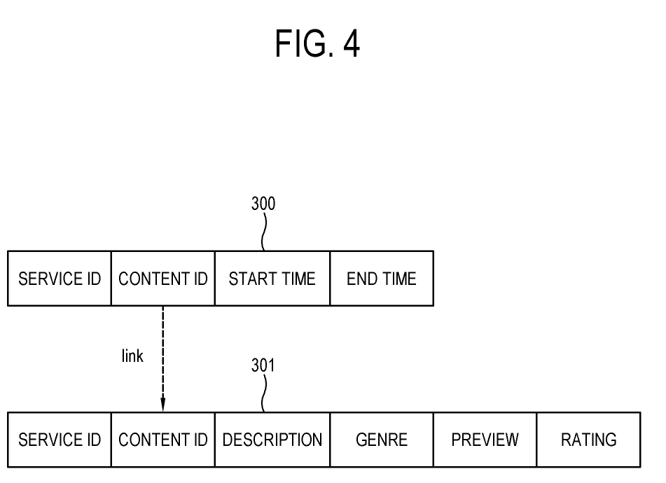

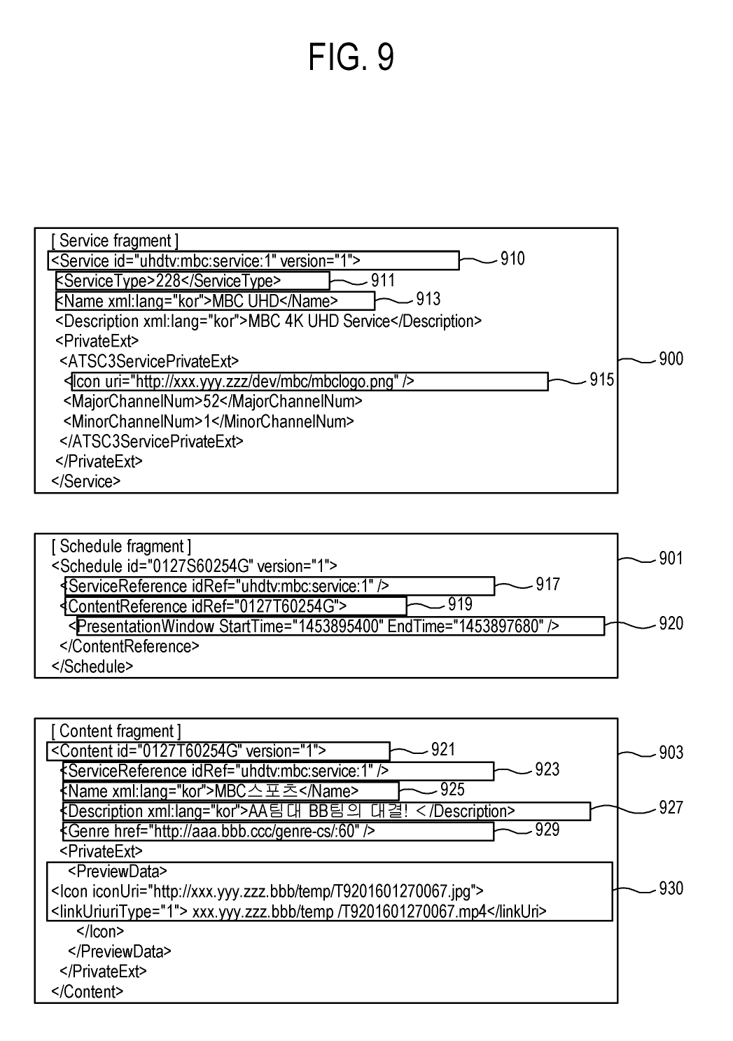

FIG. 3 and FIG. 4 are diagrams illustrating examples of the guide information according to an example embodiment, and FIG. 9 is a diagram illustrating a detailed example of each fragment.

The guide information may, for example, include three kinds of fragments 300, 301 and 302, and is transmitted through the first broadcast signal and/or the second broadcast signal.

A service fragment 302 includes, for example, information about a channel (service) of the broadcast signal. Referring to the reference numeral of ‘900’ in FIG. 9, the service fragment 302 includes, for example, service identification (ID) 910, a type 911, a service name 913, icon information 915, etc.

The schedule fragment 300 includes, for example, information about a schedule of a broadcast program included in the broadcast signal. Referring to the reference numeral of ‘901’, the schedule fragment 300 includes, for example, service ID 917 for referring to a channel, content ID 919 for referring to a broadcast program, and information 920 about a schedule of the broadcast program such as a start time and an end time of the broadcast program.

The content fragment 301 includes, for example, information about content of the broadcast program. Referring to the reference numeral of ‘903’, the content fragment 301 includes service ID 923 for referring to a channel, content ID 921, a title 925, a description 927, a genre 929, preview information 930, etc. For example, the preview information 930 is a uniform resource locator (URL), and thus the electronic apparatus 1 acquires a preview (moving images) by accessing the URL. The schedule fragment 300 for a specific broadcast program refers to a content fragment 301 having the same content ID through the reference content ID.

The controller 207 determines the sameness of the broadcast programs included in the pieces of guide information of the first broadcast signal and the second broadcast signal by comparing the reference service ID 917 and 923 and/or the reference content ID 919 and 925 included in the guide information. If the same fragments in the respective pieces of guide information have the same service ID 917 and 923 and the same content ID 919 and 925 but are different in content, the electronic apparatus 1 may provide one piece of guide information determined according to the attributes of the guide information. For example, if the schedule fragments 300 in the respective pieces of received guide information have the same service ID 917 and 923 and the same content ID 919 and 925 but are different in the schedule information 920, the controller 207 provides one piece of guide information selected according to the attributes of the guide information as the schedule fragment 300 of the corresponding content. Likewise, if the content fragments 301 in the respective pieces of received guide information have the same service ID 917 and 923 and the same content ID 919 and 925, the controller 207 provides one piece of guide information selected based on the attributes of the guide information.

The electronic apparatus 1 may determine the sameness of the broadcast program by comparing newly received guide information and the providing integrated guide information with respect to the service ID 917 and 923 and/or the content ID 919 and 925. For example, the newly received guide information and the integrated guide information may be related to one broadcast program but partially different in the included information. The controller 207 may determine whether to replace the providing integrated guide information with the newly received guide information according to the attributes of the guide information. For example, if the newly received guide information and the integrated guide information are the same with respect to the service ID 917 and 923 and the content ID 919 and 925 of the schedule fragment 300, the electronic apparatus 1 determines whether the newly received guide information is received through the first broadcast signal or the second broadcast signal, determines when the newly received guide information is generated, and so on so that the integrated guide information can be replaced, upgraded or updated with the newly received guide information, thereby more accurate guide information to a user.

The electronic apparatus 1 may generate or update the integrated guide information based on reliability of the guide information as well as a creation date and a data size of the guide information. The reliability of the guide information may be determined based on an agency of providing the guide information, how much the guide information received through the first broadcast signal or the second broadcast signal is edited by a user, a path of receiving the guide information, etc. For example, if the agency of providing the guide information is an officially approved broadcasting station, it may be determined that the reliability is high. If the guide information received through the first broadcast signal is more edited by a user, it may be determined that the reliability is low.

The electronic apparatus 1 may generate and update the integrated guide information based on a provider of the guide information. For example, the electronic apparatus 1 may generate and provide the integrated guide information using only the guide information of a specific main agent according to a user's selection. The electronic apparatus 1 may generate the integrated guide information by using the guide information provided by a providing agent selected according to channels or timeslots with regard to the broadcast programs.

In addition, the electronic apparatus 1 may generate the integrated guide information based on a user's preference. For example, if the integrated guide information is generated as a user frequently selects the first guide information with respect to a specific broadcast program, channel and timeslot, the electronic apparatus 1 determines that the user prefers the first guide information with respect to the specific broadcast program, the channel of providing the broadcast program, or the timeslot of the broadcast program. The electronic apparatus 1 may generate and provide the integrated guide information based on the first guide information preferred by a user even though the foregoing references such as the attributes of the guide information are given in terms of providing the integrated guide information with respect to a specific broadcast program, channel or timeslot.

The electronic apparatus 1 may complexly take the foregoing various references into account to provide the guide information.

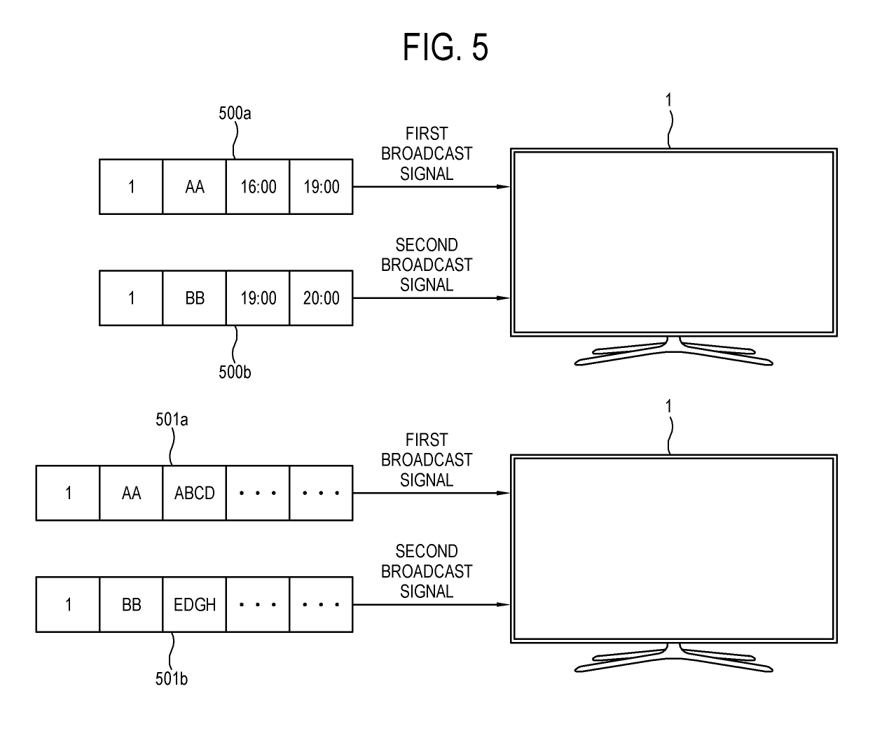

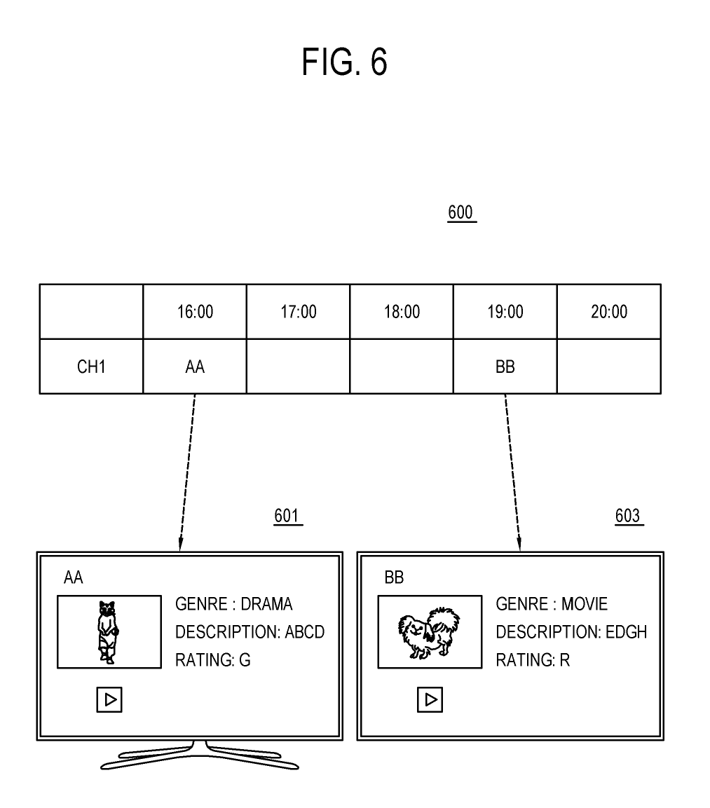

FIG. 5 is a diagram illustrating an example of receiving the guide information through each broadcast signal according to an example embodiment, and FIG. 6 is a diagram illustrating an example of providing the guide information embedded in each broadcast signal according to an example embodiment. If pieces of first guide information 500a and 501a received through the first broadcast signal and pieces of second guide information 500b and 501b received through the second broadcast signal are respectively related to different broadcast programs, the electronic apparatus 1 generates and provides pieces of integrated guide information 600, 601 and 603 including pieces of guide information 500a, 500b, 501a and 501b. For example, if the schedule fragment 300 of the first guide information 500a is related to the AA content of a first channel and the schedule fragment 300 of the second guide information 500b is related to the BB content of the first channel, the schedule 600 of the AA content and the BB content in the completed pieces of integrated guide information 600, 601, 603 is provided based on both the first guide information 500a and the second guide information 500b. Likewise, if the content fragment 301 of the first guide information 501a is related to the AA content and the content fragment 301 of the second guide information 501b is related to the BB content of the first channel, the information 601 of the AA content is provided based on the first guide information 501a among the pieces of integrated guide information 600, 601 and 603 and the information 603 of the BB content is provided based on the second guide information 501b. That is, the electronic apparatus 1 generates and provides the pieces of integrated guide information 600, 601 and 603 based on all the pieces of received guide information 500a, 500b, 501a and 501b as long as the pieces of guide information 500a, 500b, 501a and 501b of the respective broadcast signals do not overlap or conflict with one another.

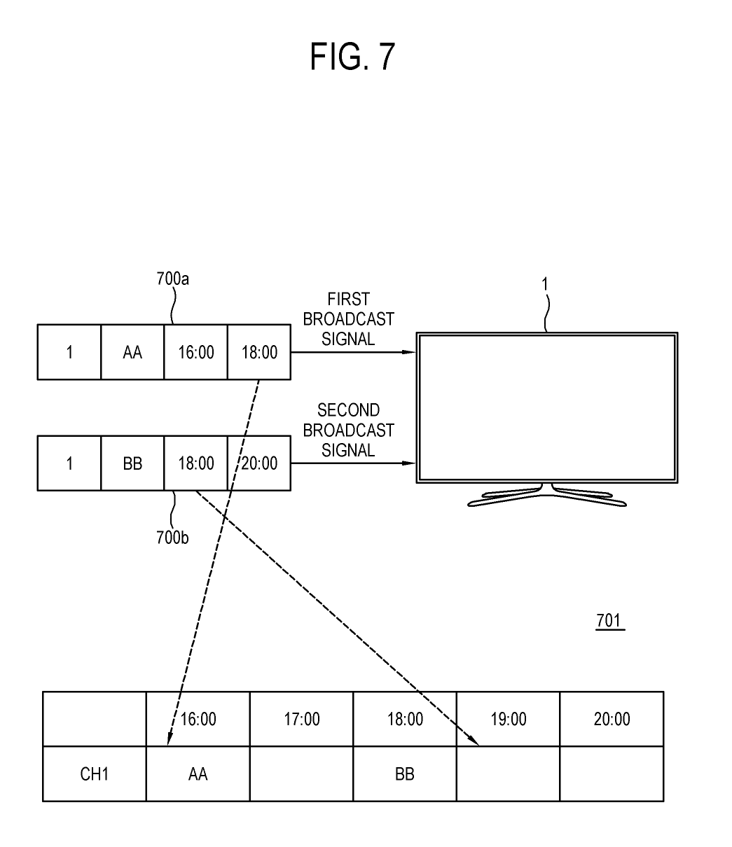

FIG. 7 is a diagram illustrating an example of replacing a schedule fragment of the existing guide information with additional guide information embedded in the broadcast signal according to an example embodiment. In this example embodiment, the electronic apparatus 1 additionally receives third guide information 700a and 700b through the first broadcast signal. If the third guide information 700a and 700b including the schedule information of the broadcast program is received through the first broadcast signal after the schedule 600 of the integrated guide information is generated based on the first guide information 500a and the second guide information 500b, the electronic apparatus 1 determines whether to replace the schedule 600 of the integrated guide information according to the attributes of the third guide information 700a and 700b.

To determine whether to replace the schedule 600 of the integrated guide information, the electronic apparatus 1 considers whether the third guide information 700a and 700b is recently generated, is received through the frequently updated first broadcast signal, or the like.

In this example embodiment, the electronic apparatus 1 provides a schedule 701 of new integrated guide information by replacing the schedule 600 of the integrated guide information with the more recently generated and newly received third guide information 700a and 700b. In case of the first guide information 500a and the third guide information 700a are received through the same first broadcast signal, the electronic apparatus 1 determines which one is more recently received between them. In case of the second guide information 500b and the fourth guide information 700b respectively received through different broadcast signals, the electronic apparatus 1 replaces a part corresponding to the second broadcast signal within the integrated guide information 600 with the third guide information 700b received through the more-frequently undated first broadcast signal.

In this example embodiment, it is described that the schedule 600 of the integrated guide information and the third guide information 700a and 700b are the pieces of guide information given with regard to the same broadcast program as a result of referring to the content ID 919 and 925, but have conflict schedules as a result of referring to the schedule information 920.

However, this is not to be understood as limiting the present disclosure. For example, the third guide information 700 and 700b may show that CC content is broadcasted from 18:00 to 20:00. In this case, the electronic apparatus 1 determines that the integrated guide information 600 and the third guide information 700a and 700b are respectively related to different broadcast programs, but show the schedule of the same channel based on the service ID. If the respective pieces of guide information 500a, 500b, 700a and 700b include the broadcast program schedule of the same channel, the electronic apparatus 1 may determine whether to replace a part of the integrated guide information 600 with the third guide information 700a and 700b in accordance with the attributes of the guide information 700a and 700b.

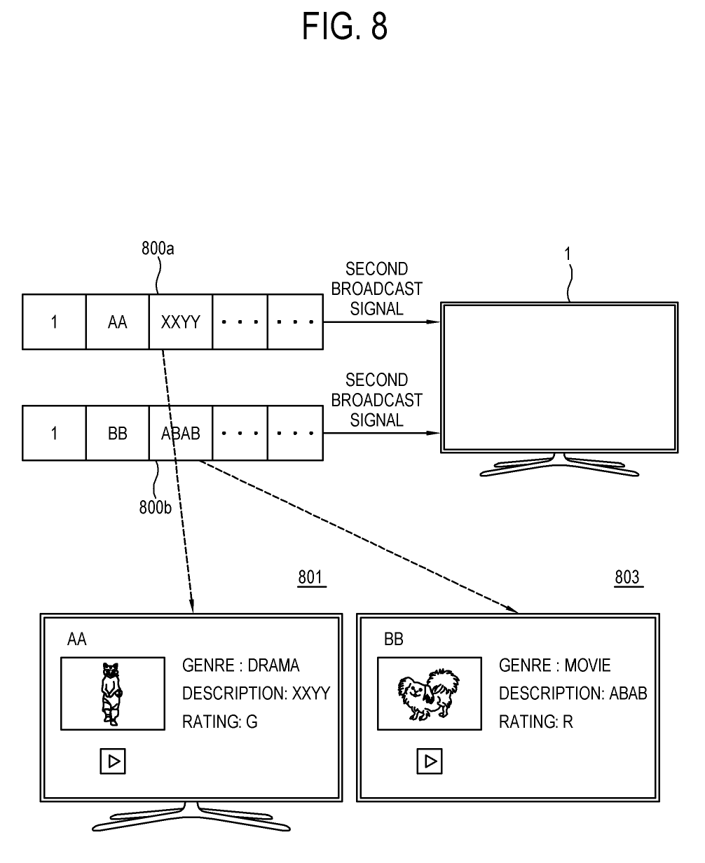

FIG. 8 is a diagram illustrating an example of replacing a content fragment of the existing guide information with additional guide information embedded in the broadcast signal according to an example embodiment. If the fourth guide information 800a and 800b is received through the second broadcast signal after generating the information 601 and 603 about the content within the integrated guide information, the electronic apparatus 1 determines whether to replace, upgrade or update the integrated guide information according to the attributes of guide information.

For example, if the fourth guide information 800a and 800b includes the content fragment 301 to which it matters how much information is included therein, the electronic apparatus 1 may determine whether to replace a part of the integrated guide information based on whether the data size of the fourth guide information 800a and 800b is greater than that of the information 601 and 603 about the content of the integrated guide information or whether the fourth guide information 800a and 800b is received through the second broadcast signal that can carry more data.

In this example embodiment, the electronic apparatus 1 provides the integrated guide information changed in the information 801 and 803 about the content by replacing the information 601 and 603 about the content of the integrated guide information with the newly received fourth guide information 800a and 800b. In case of the second guide information 501b and the fourth guide information 800b received through the same second broadcast signal, the electronic apparatus 1 determines which one of the guide information 501b and 800b is more recently generated or includes a larger amount of data between them. In case of the second guide information 501b and the fourth guide information 800b respectively received through different broadcast signals, the electronic apparatus 1 replaces a part corresponding to the first guide information 501a within the integrated guide information with the fourth guide information 800b received through the second broadcast signal that can include a large amount of information.

According to an example embodiment, if the integrated guide information 601 and 603 and the fourth guide information 800a and 800b have the same content ID 919 and 925 even though they are different in service ID 917 and 923, the controller 207 may determine whether to replace the information 601 and 603 about the content of the integrated guide information with the fourth guide information 800a and 800b.

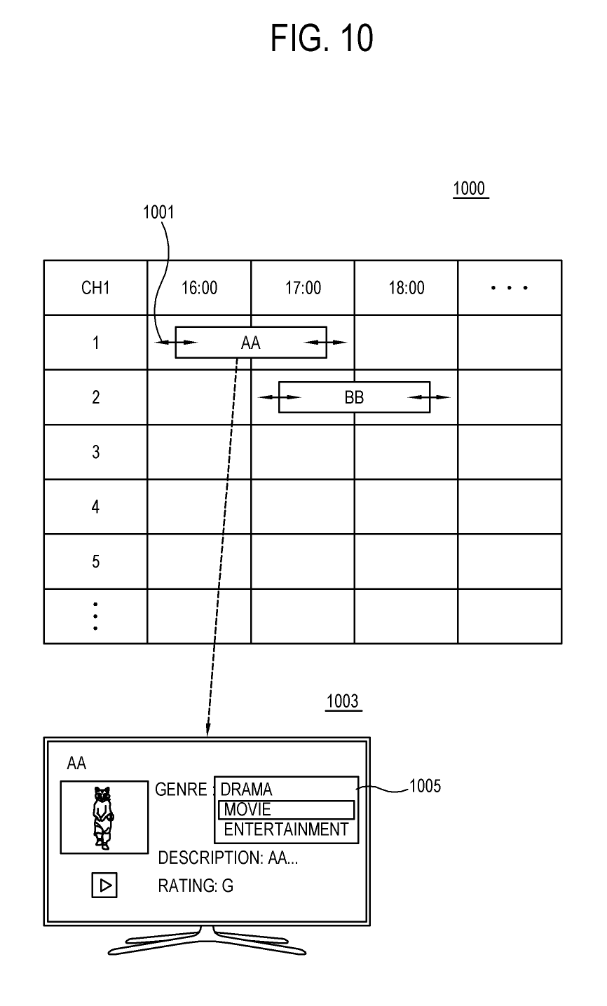

FIG. 10 is a diagram illustrating an example of a user interface (UI) provided for allowing a user to edit the guide information according to an example embodiment. While providing the integrated guide information including schedule information 1000 and content information 1003 based, for example, on the first guide information 500a and 501a and the second guide information 500b and 501b, the electronic apparatus 1 provides a UI 1001 for allowing a user to change a schedule of content. The electronic apparatus 1 may provide a UI 1005 for allowing a user to add/change/delete a specific item of the content information 1003. The UIs 1001 and 1005 for allowing a user to edit the guide information 1000 and 1003 are not limited to those illustrated in FIG. 10.

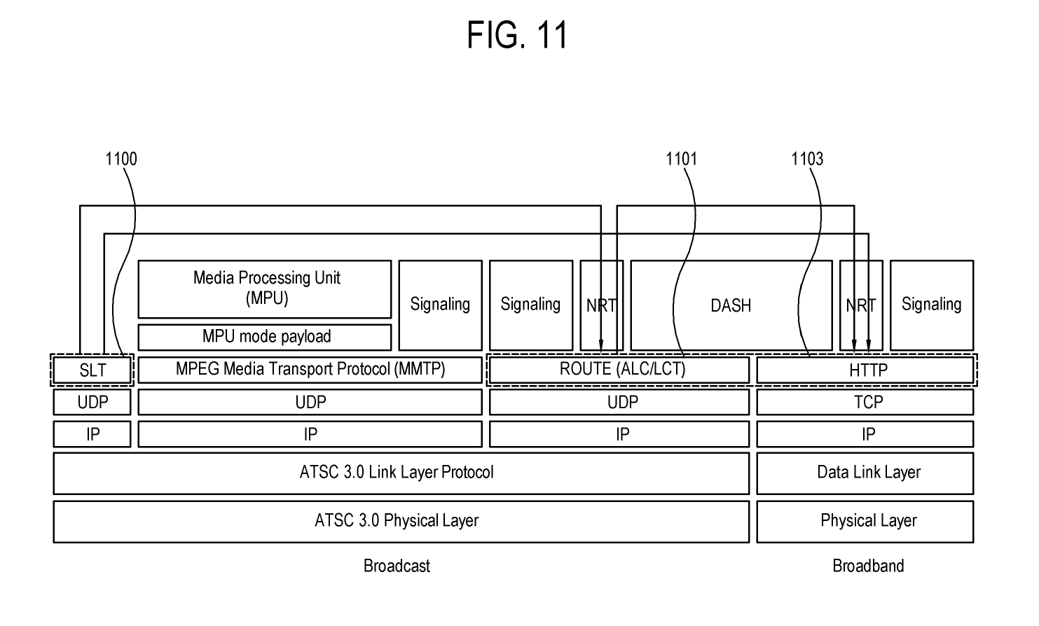

FIG. 11 is a block diagram illustrating example ATSC 3.0 standards according to an example embodiment.

According to the ATSC 3.0 standards, there are two methods of transmitting the first broadcast signal via a terrestrial path. One is transmitting media processing units (MPU) through MPEG media transport protocol (MMTP) based on MMT, and the other one is transmitting dynamic adaptive streaming over HTTP (DASH) segments through real-time object delivery over unidirectional transport (ROUTE) 1101 based on MPEG DASH. Content transmitted using the MMTP and content transmitted using the ROUTE 1101 may be collection of media components to be shown to a user. The content may be given in real time or non-real time (NRT). For example, the real time content includes a broadcast content, and the non-real time content includes guide information about content.

The second broadcast signal may be transmitted through a hypertext transfer protocol (HTTP) 1103. The DASH segment, signaling information, NRT or the like information may be transmitted through the HTTP 1103. This kind of data is encapsulated in a link layer via transmission control protocol (TCP) and Internet protocol (IP) layers, subjected to a process for transmission in a physical layer, and then transmitted. The second broadcast signal is transmitted through Internet 10 and includes a plurality of frequency-division multiplexed channels.

A service list table (SLT) 1100 includes information needed for receiving channels of the first broadcast signal and the second broadcast signal. The electronic apparatus 1 may generate a channel list including a plurality of channels receivable in the electronic apparatus 1 based on the SLT 1100 during auto-scanning. The SLT may be encapsulated via user datagram protocol (UDP) and Internet protocol (IP) layers.

As described above, the guide information may be embedded in both the first broadcast signal and the second broadcast signal. However, the electronic apparatus 1 may acquire the guide information from the ROUTE 1101 of the first broadcast signal and the HTTP 1103 of the second broadcast signal based on the SLT 1100 received through the first broadcast signal.

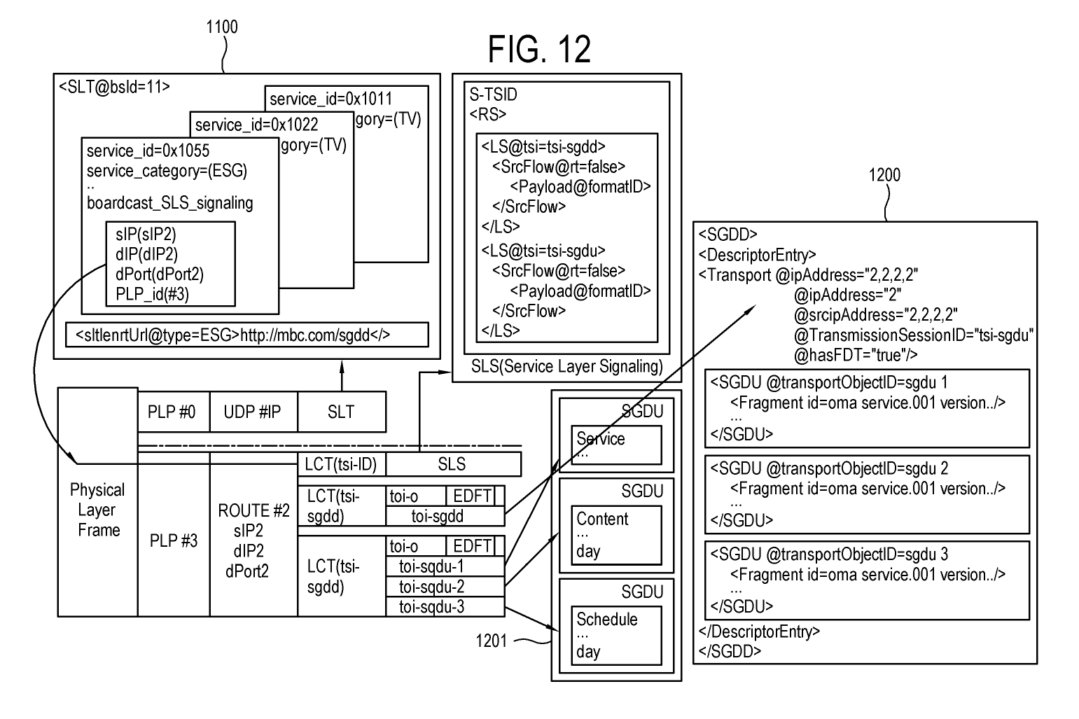

FIG. 12 is a diagram illustrating an example of obtaining guide information of a first broadcast signal in the ATSC 3.0 standards according to an example embodiment. The guide information of the first broadcast signal is transmitted using the ROUTE 1101 through a NRT file. The electronic apparatus 1 refers to a service guide delivery descriptor (SGDD) 1200 and a service guide delivery unit (SGDU) 1201 in the ROUTE 1101 based on the SLT. As a descriptor for indicating items in the guide information, the SGDD 1200 provides a data range of the transmitted guide information and location information of the SGDU 1201. The SGDU 1201 includes a service fragment 302, a content fragment 301 and a schedule fragment 300 which are actually provided. The electronic apparatus 1 determines the kind and range of guide information by checking the SGDD 1200 based on the SLT 1100, and receives information about a program through the SGDU 1201. The SGDU 1201 of the first broadcast signal may be for example set to be updated every day.

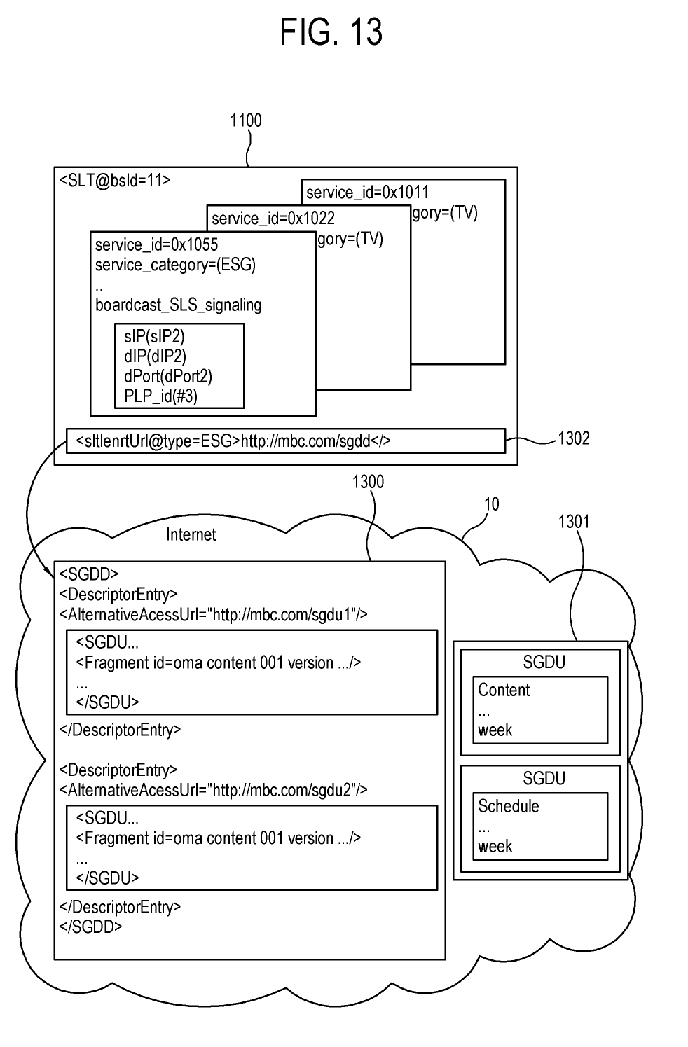

FIG. 13 is a diagram illustrating an example of obtaining guide information of a second broadcast signal in the ATSC 3.0 standards according to an example embodiment. The guide information may be received through both the first broadcast signal and the second broadcast signal. In this example embodiment, the electronic apparatus 1 acquires the guide information of the second broadcast signal based on the guide information using the SLT 1100 embedded in the first broadcast signal. For example, the location of the guide information transmitted through the second broadcast signal is known through a sltInetUrl element 1302 of the SLT 1100. The electronic apparatus 1 checks a URL by which the SGDD 1300 of the guide information is transmitted through the sltInetUrl element 1302, and acquires the SGDD 1300 and the SGDU 1301 by accessing the URL. The guide information transmitted through the second broadcast signal may be defined as a separate service in the SLT 1100. The SGDU 1300 of the second broadcast signal may be for example set to be updated every week.

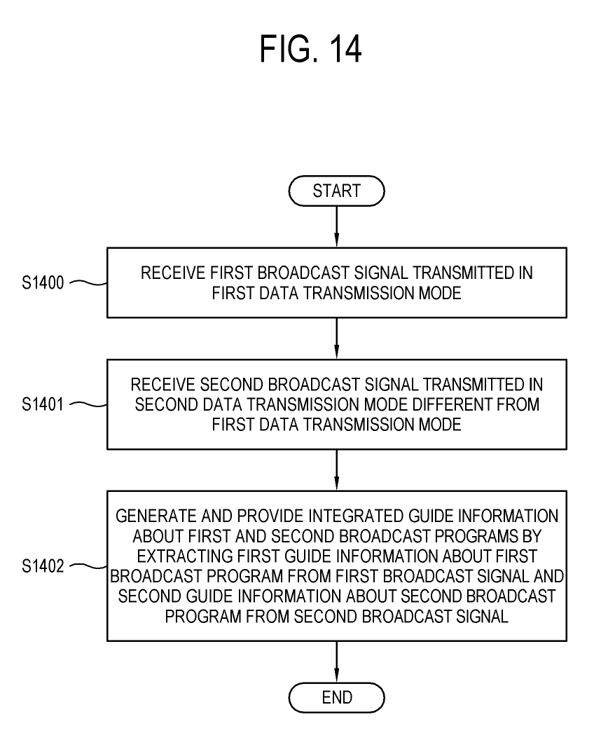

FIG. 14 is a flowchart illustrating an example method of operating an electronic apparatus according to an example embodiment. At operation S1400, the first receiver 200 receives the first broadcast signal transmitted in the first data transmission mode. At operation S1401, the second receiver 201 receives the second broadcast signal in the second data transmission mode different from the first data transmission mode. At operation S1402, the controller 207 extracts the first guide information about the first broadcast program from the first broadcast signal and the second guide information about the second broadcast program from the second broadcast signal, and generates and provides the integrated guide information about the first and second broadcast programs.

In addition, if the third guide information about the second broadcast program is embedded in the first broadcast signal, the controller 207 may replace a part corresponding to the second guide information within the integrated guide information with the third guide information according to the attributes of the third guide information. The controller 207 replaces the integrated guide information with the third guide information based on whether the third guide information is related to a schedule or content information. For example, if the third guide information is related to the schedule of the content, the part corresponding to the second guide information within the integrated guide information is replaced with the third guide information when the third guide information is more recently generated or the third guide information is embedded in the first broadcast signal. If the third guide information is related to the description of the content, the second guide information is replaced with the third guide information when the data size of the third guide information is more than that of the second guide information or the third guide information is embedded in the second broadcast signal.

The controller 207 may replace the part corresponding to the second guide information within the integrated guide information with the third guide information based on a provider, reliability and a user's preference with regard to the third guide information.

In addition, the controller 207 may replace the part corresponding to the first guide information within the integrated guide information with the fourth guide information received through the second broadcast signal.

Besides, the same or similar features of the electronic apparatus 1 described with reference to FIG. 1 to FIG. 13 may be applied to the method of controlling the electronic apparatus 1 illustrated in FIG. 14.

As described above, according to an example embodiment, guide information of high accuracy is provided to a user among a plurality of pieces of guide information, and it is thus convenient for a user to use content.

Although various example embodiments have been illustrated and described, it will be appreciated by those skilled in the art that changes may be made in these example embodiments without departing from the principles and spirit of the disclosure, the scope of which is defined in the appended claims and their equivalents.

What is claimed is:

1. An electronic apparatus comprising:
a first receiver comprising circuitry configured to receive a first broadcast signal transmitted in a first data transmission mode;
a second receiver comprising circuitry configured to receive a second broadcast signal transmitted in a second data transmission mode different from the first data transmission mode; and
a controller configured to extract first guide information about a first broadcast program from the first broadcast signal, to extract second guide information about a second broadcast program from the second broadcast signal, and to generate and provide integrated guide information about the first and second broadcast programs.

2. The electronic apparatus according to claim 1, wherein the controller is configured to replace a part of the guide information corresponding to the second guide information within the integrated guide information with third guide information based on attributes of the third guide information if the third guide information about the second broadcast program is received through the first broadcast signal.

3. The electronic apparatus according to claim 2, wherein the controller is configured to replace a part of the guide information corresponding to the second guide information within the integrated guide information with third guide information if the third guide information is more recently generated than the second guide information.

4. The electronic apparatus according to claim 2, wherein the controller is configured to replace a schedule of the second broadcast program within the integrated guide information with the third guide information if the third guide information is related to the schedule, the third guide information comprising a start time and an end time of the second broadcast program.

5. The electronic apparatus according to claim 2, wherein the controller is configured to replace at least one of: a genre, a description, a rating and a preview of the second broadcast program within the integrated guide information with the third guide information if the third guide information comprises at least one of: the genre, the description, the rating and the preview of the second broadcast program.

6. The electronic apparatus according to claim 2, wherein the controller is configured to compare the third guide information and the second guide information with respect to a data size, and to replace a part of the guide information corresponding to the second guide information within the integrated guide information with the third guide information if the third guide information has a larger data size than the second guide information.

7. The electronic apparatus according to claim 2, wherein the controller is configured to replace a part of the guide information corresponding to the second guide information within the integrated guide information with the third guide information based on at least one of: a provider of the third guide information and a reliability of the third guide information.

8. The electronic apparatus according to claim 2, wherein the controller is configured to replace a part of the guide information corresponding to the first guide information within the integrated guide information with fourth guide information based on attributes of the fourth guide information if the fourth guide information about the first broadcast program is received through the second broadcast signal.

9. The electronic apparatus according to claim 8, wherein the third guide information is more frequently updated than the fourth guide information.

10. The electronic apparatus according to claim 8, wherein the fourth guide information has a larger data size than the third guide information.

11. A method of controlling an electronic apparatus, the method comprising:
receiving a first broadcast signal transmitted in a first data transmission mode;
receiving a second broadcast signal transmitted in a second data transmission mode different from the first data transmission mode;
extracting first guide information about a first broadcast program from the first broadcast signal;
extracting second guide information about a second broadcast program from the second broadcast signal; and
generating and providing integrated guide information about the first and second broadcast programs.

12. The method according to claim 11, further comprising:
replacing a part of the guide information corresponding to the second guide information within the integrated guide information with third guide information based on attributes of the third guide information if the third guide information about the second broadcast program is received through the first broadcast signal.

13. The method according to claim 12, wherein the replacing a part of the guide information corresponding to the second guide information within the integrated guide information with third guide information comprises:
replacing a part of the guide information corresponding to the second guide information within the integrated guide information with third guide information if the third guide information is more recently generated than the second guide information.

14. The method according to claim 12, wherein the replacing a part of the guide information corresponding to the second guide information within the integrated guide information with third guide information comprises:
replacing a schedule of the second broadcast program within the integrated guide information with the third guide information if the third guide information is related to the schedule, the third guide information comprising a start time and an end time of the second broadcast program.

15. The method according to claim 12, wherein the replacing a part of the guide information corresponding to the second guide information within the integrated guide information with third guide information comprises:
replacing at least one of: a genre, a description, a rating and a preview of the second broadcast program within the integrated guide information with the third guide information if the third guide information comprises at least one of: the genre, the description, the rating and the preview of the second broadcast program.

16. The method according to claim 12, wherein the replacing a part of the guide information corresponding to the second guide information within the integrated guide information with third guide information comprises:
comparing the third guide information and the second guide information with respect to a data size; and
replacing a part of the guide information corresponding to the second guide information within the integrated guide information with the third guide information if the third guide information has a larger data size than the second guide information.

17. The method according to claim 12, wherein the replacing a part of the guide information corresponding to the second guide information within the integrated guide information with third guide information comprises:
replacing a part of the guide information corresponding to the second guide information within the integrated guide information with the third guide information based on at least one of: a provider of the third guide information and a reliability of the third guide information.

18. The method according to claim 12, further comprising: replacing a part of the guide information corresponding to the first guide information within the integrated guide information with fourth guide information based on attributes of the fourth guide information, if the fourth guide information about the first broadcast program is received through the second broadcast signal.

19. The method according to claim 18, wherein the third guide information is more frequently updated than the fourth guide information.

20. The method according to claim 18, wherein the fourth guide information has a larger data size than the third guide information.
